(19) United States
(12) Patent Application Publication
(10) Pub. No.: US 2010/0205424 A1
(43) Pub. Date: Aug. 12, 2010

(54) METHOD FOR BOOTING COMPUTER SYSTEM AUTOMATICALLY

(75) Inventor: MING-JUNG WU, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTeK COMPUTER INC., Taipei (TW)

(21) Appl. No.: 12/694,708

(22) Filed: Jan. 27, 2010

(30) Foreign Application Priority Data
Feb. 12, 2009 (TW) 098104548

(51) Int. Cl. G06F 15/177

(52) U.S. Cl. 713/2

(57) ABSTRACT

A method for booting a computer system automatically includes steps as follows. A booting time point is set. The computer system is booted at the booting time point. A standby mode is entered immediately after the computer system is booted.

### FIELD OF THE INVENTION

The invention relates to a method for controlling a computer system and, more particularly, to a method for booting a computer system automatically.

### BACKGROUND OF THE INVENTION

Generally, to use a notebook computer or a personal computer, a user usually spends more than one minute in powering on, entering an operating system and loading the operating system completely. When a user loads a plurality of applications, drivers or anti-virus software to the operating system of the computer, the booting time of the computer may last even longer.

In addition, when the user needs to operate the computer that is in the standby mode, the computer may be restored from the standby mode to the original operating state in the operating system environment. However, generally, users often don't know much about the function of the standby mode, and thus the utilization ratio of the standby mode is not high.

Furthermore, for the computer can be operated instantly, users usually don't shut down the computer directly but leave the computer enters the standby mode even for a long time (such as a whole night). However, the computer may consume more power in the standby mode for a long time than in a shutdown state.

### SUMMARY OF THE INVENTION

The invention discloses a method for booting a computer system automatically. The method includes steps as follows. A booting time point is set. The computer system is booted at the booting time point. A standby mode is entered immediately after the computer system is booted.

In addition, the invention also discloses a method for booting a computer system automatically. The computer system has an initial booting time point. The method includes the steps as follows. A plurality of using time points are recorded. The using time points and an initial booting time point are compared and an updated booting time point is generated. The computer system is booted at the updated booting time point. A standby mode is entered after the computer system is booted.

In the method for booting the computer system automatically, according to the using habit of the user, the booting time point of the computer system is adjusted dynamically, and the computer system is booted at the booting time point. The computer system enters the standby state directly after it is booted. Thus, to the computer system, an energy-saving objective is achieved, and the user may use the computer without spending much time in waiting for the computer system to be booted.

### BRIEF DESCRIPTION OF THE DRAWINGS

These and other features, aspects and advantages of the present invention will become better understood with regard to the following description, appended claims, and accompanying drawings.

FIG. 1 shows a method for booting the computer system automatically in an embodiment of the invention; and

FIG. 2 shows a method for determining the booting time point of the computer system in an embodiment of the invention.

### DETAILED DESCRIPTION OF THE PREFERRED EMBODIMENT

Nowadays, since a user pays more and more attention to an energy-saving effect of a computer and peripherals, an advanced configuration and power interface (ACPI) is provided. The ACPI is the most commonly used power management specification in a computer operating system, and it may divide the computer states to a G0 state, a G1 state, a G2 state and a G3 state. The G1 state is further divided into a S0 state, a S1 state, a S2 state, a S3 state and a S4 state.

The user is most familiar with the S3 state which is usually called a suspend state (or suspend to ram). The S3 state is a standby mode of the computer system, and in the S3 state, peripheral devices of the computer (such as a CPU, a computer display screen, a modem or a loudspeaker) may be powered off. At that moment, the operating state in the operating system environment used by the user (such as the executed application) may be stored in a main memory, and only a little power is supplied to maintain the operation of the main memory. When the user needs to wake up the computer, the computer may be restored to the operating state of the operating system environment before the standby mode in five seconds.

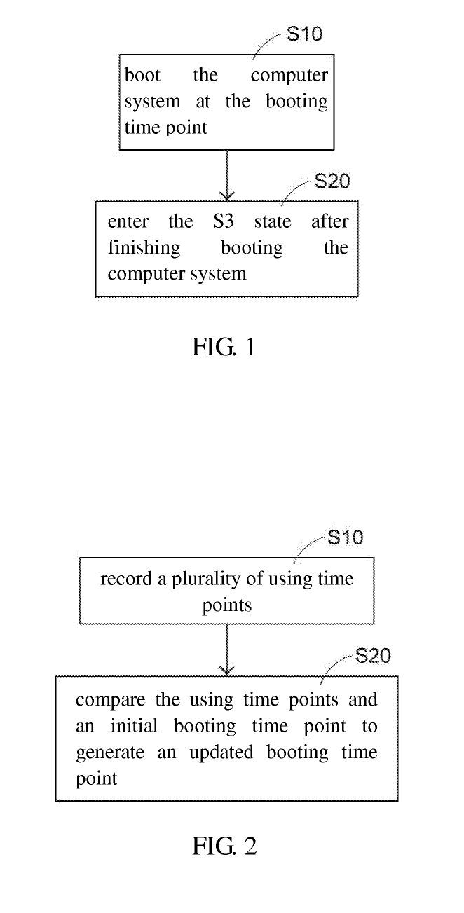

FIG. 1 shows a method for booting the computer system automatically in an embodiment of the invention. After the user sets a booting time point in a basic input/output system (BIOS), the computer system is booted every day at the booting time point (step S10). Then, the computer system enters the S3 state after it is booted (step S20).

According to an embodiment of the invention, the user presets the booting time point and the power state after the booting procedure in the BIOS of the computer system. At the booting time point, the computer system is booted automatically. In addition, after the computer system is booted, the computer system enters the S3 state.

Thus, when the user uses the computer after the computer system is booted at the booting time point for a long time, since the computer system stays at the S3 state, it does not consume much energy and may immediately enter the normal state from the S3 state in five seconds. By using the invention, the user does not need to spend much time in waiting for the computer system to be booted.

In addition, according to an embodiment of the invention, the user may set the booting time point to be a dynamical booting time point in the BIOS. That is, the booting time point of the computer system may be adjusted dynamically.

That is, when the user sets the dynamical booting time point in the BIOS, the computer system may record a plurality of using time points of the user in the non-volatile memory of the computer system such as the flash memory. In addition, the using habit of the user is obtained and the booting time point is adjusted more precisely according to the using time points. Therefore, the computer system may consume less power, and the user may use the computer system immediately.

For example, supposing that the initial booting time point is set to be three o′clock, thus the computer system is booted automatically at three o′clock every day, and after the booting procedure, the computer system enters the S3 state. However, if the user uses the computer at ten past four and restores the computer system to the normal state from the S3 state, and that is, the time ten past four is the actual operation time for the user to operate the computer, the time ten past four is set to be the using time point by the computer system and recorded in the computer system.

Similarly, supposing that after some days, the recorded using time points are ten past four, a quarter past four, eight past four and eleven past four, the computer system then knows the user's habit, and the initial booting time point is adjusted to be an updated booting time point such as three past four. Thus, the computer system may be booted automatically at three past four every day, and then it enters the S3 state after booted. Thus, consumed energy is reduced, and the user also may use the computer system immediately.

In addition, supposing that the initial booting time point is set at three o′clock, and the user boots the computer before the booting time point such as at two thirty, at that moment, the user has to spend some time in waiting for the computer system to be booted, and the computer system may set two thirty to be the using time point and record it in the computer system.

Similarly, supposing that after some days, all the recorded using time points are before three o′clock, and for example, they may be two thirty, twenty five past two, twelve past two and ten past two, the computer system then knows the user's habit, and then the initial booting time point is adjusted to the updated booting time point such as the seven past two. Thus, at seven past two every day, the computer system is booted automatically and the S3 state is entered after the booting procedure. Thus, the user does not need to wait for the computer system to be booted, and he or she may use the computer system immediately.

The using time point may be before the booting time point or after the booting time point. Supposing that the initial booting time point is set at three o′clock, and after a few days, the recorded using time points are ten past four, fifteen past four, eighteen past four and two thirty, the computer system then knows the user's habit and ignores the using time point two thirty, and it may adjust the initial booting time point to the updated booting time point. For example, it may adjust the updated booting time point to five past four, and every day at five past four, the computer system is booted automatically, and then the S3 state is entered.

FIG. 2 shows a method for determining the booting time point in the computer system. When the user sets the dynamic booting time point in the BIOS, and the dynamic booting time point has an initial booting time point, the computer system may record a plurality of using time points (step S30). Afterwards, the using time points and the initial booting time point are compared to generate an updated booting time point (step S40).

Thus, in the invention, according to the habit of the user, the booting time point of the computer system is adjusted dynamically, and the computer system is booted at the booting time point. After the computer system is booted, it enters the S3 state directly, and thus the energy-saving effect is achieved. In addition, the user does not need to spend much time in waiting for the computer system to be booted, and he or she may use the computer immediately.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for booting a computer system automatically, comprising the steps of:
setting a booting time point;
booting the computer system at the booting time point; and
entering a standby mode immediately after finishing booting the computer system.

2. The method for booting the computer system automatically according to claim 1, wherein the standby mode is to control the computer system to enter a suspend state.

3. The method for booting the computer system automatically according to claim 1, wherein the booting time point is set in a basic input/output system (BIOS) of the computer system.

4. A method for booting a computer system automatically, wherein the computer system has an initial booting time point, the method comprising the steps of:
recording a plurality of using time points;
comparing the using time points with the initial booting time point and generating an updated booting time point;
booting the computer system at the updated booting time point; and
entering a standby mode after finishing booting the computer system.

5. The method for booting the computer system automatically according to claim 4, wherein the standby mode is to control computer system to enter a suspend state.

6. The method for booting the computer system automatically according to claim 4, wherein the booting time point is set in a BIOS of the computer system.

7. The method for booting the computer system automatically according to claim 4, wherein the using time points are a plurality of actual times at which the user operates the computer system.

8. The method for booting the computer system automatically according to claim 4, wherein the using time points are recorded in a non-volatile memory.

9. The method for booting the computer system automatically according to claim 8, wherein the non-volatile memory is a flash memory.
